(19) United States
(12) Patent Application Publication
(10) Pub. No.: US 2005/0218199 A1
(43) Pub. Date: Oct. 6, 2005

(54) Video Postcard

(76) Inventor: Robert Wayne Crevier, Aliso Viejo, CA (US)

Correspondence Address: Robert Crevier, 65 Enterprise, Aliso Viejo, CA, 92656, US

(21) Appl. No.: 10/708,922

(22) Filed: Mar. 31, 2004

(51) Int. Cl. B42D 15/00

(52) U.S. Cl. 229/92.8

(57) ABSTRACT

The Video Postcard is new and unique to the travel and tourism industry as the first updated version of the common postcard in over one hundred years, by combining a DVD travel documentary and packaged in a custom designed postcard self-mailer. Sold as a retail item and also used in marketing efforts for those who benefit in the travel and tourism industry.

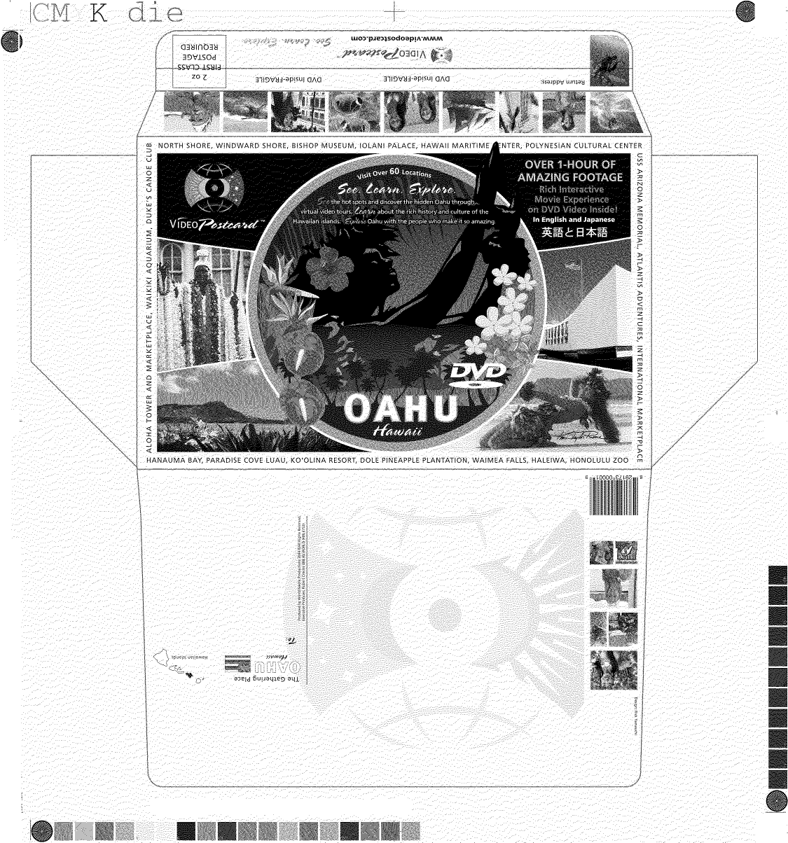

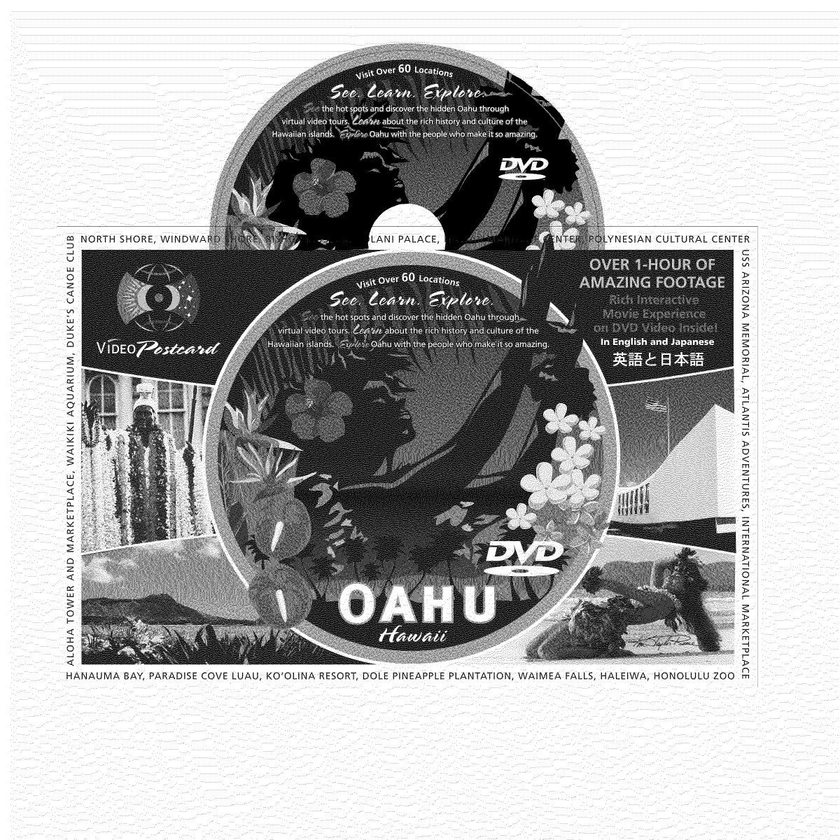

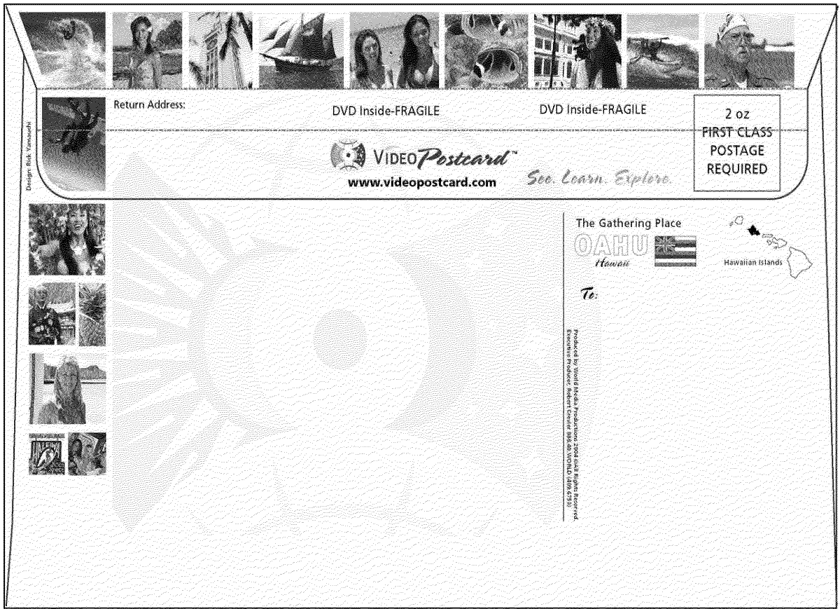

### DETAILED DESCRIPTION

The Video Postcard is a product with a custom designed Postcard envelope self-mailer containing a DVD video production inside. The product is used in the travel and tourism industry. The product is sold as a retail item and also used as a wholesale marketing tool. The product can be customized to suit a company's marketing needs. One simply writes a message and address on the outside of the Postcard, applies proper postage and mails through traditional postal process. Recipient of the Video Postcard simply removes opening tear strip, removes DVD from Postcard envelope and places the DVD in a DVD player. The recipient/viewer will see a travel documentary compete with sound, music, testimonials and video photography of a particular travel destination.

1. The video postcard is unique and proprietary as a retail item and as a marketing tool in the travel and tourism industry.
